(19) United States
(12) Patent Application Publication
(10) Pub. No.: US 2009/0214312 A1
(43) Pub. Date: Aug. 27, 2009

(54) METHOD FOR OPTIMIZED MILLING CLOSE TO THE FINAL CONTOUR

(75) Inventor: Mark Geisel, Gauting (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/390,848

(22) Filed: Feb. 23, 2009

(30) Foreign Application Priority Data
Feb. 25, 2008 (DE) 10 2008 010 983.5

(51) Int. Cl. B23C 3/00; G06F 19/00

(52) U.S. Cl. 409/132; 700/95

(57) ABSTRACT

A method for optimized milling of workpieces close to the final contour, in particular chamfers on turbine blades, is disclosed. The method is characterized in that a numeric optimization method is provided for the automatic control of the kinematic sequences of motion, wherein an additional rotation around an axis parallel to the tool axis is optimized in terms of kinematic and/or kinetic and/or workpiece-specific manufacturing criteria. With the method, it is possible to achieve optimum results in the milling of chamfers close to the final contour or in the deburring of workpiece edges. In this case, the method makes it possible in particular to make available a path optimization that is required in order to achieve an optimum processing result, wherein this optimization is preferably automated and can take place within a short time. In addition, the inventive method achieves a high level of series stability in manufacturing.

This application claims the priority of German Patent Document No. 10 2008 010 983.5, filed Feb. 25, 2008, the disclosure of which is expressly incorporated by reference herein.

### BACKGROUND AND SUMMARY OF THE INVENTION

The invention relates to a method for the optimized milling of workpieces close to the final contour, in particular of chamfers on turbine blades.

In the course of processing workpieces, chamfers are also frequently required, i.e., bevels of the workpiece edges, which normally have small dimensions as compared to the overall dimensions of the workpiece. These chamfers are applied at a specific angle, such as 45 degrees for example, by means of a metal-cutting method. These types of chamfers may either be used for structural purposes, for example when they serve as slide surfaces or limit stops, or they may also fulfill safety-related functions. The latter application in particular is to be found practically everywhere where the affected component edges carry with them the risk of injury, whether this is during assembly or during the subsequent operation of a device that includes the component. Sharp edges with partially projecting chips, so-called burrs, are generated in this case especially when processing metallic materials by means of metal-cutting methods such as, for example, milling, and namely especially when the angle between the adjacent surfaces is not an obtuse angle.

Depending upon the function to be fulfilled, we will speak in this context either of a chamfered edge (structural function; more likely to have larger and more exactly determined dimensions with smaller relative tolerances) or a deburring (safety-related function; more likely to have small to the smallest dimensions that are often less precisely determinable, with larger relative tolerances).

While in the case of individual parts or workpieces with large tolerances for removing burrs or for chamfering as well as in the subsequent processing of already installed workpieces, manual methods such as, for example, filing come into play, chamfering or deburring is put into operation in series production preferably in an automated manner using appropriate machines. For workpieces that are essentially straight, permanently mounted machines, for example, a carriage may be used, on which the to-be-processed workpiece is fed along the chamfer milling tool and thereby deburred or chamfered. In the case of more complex geometries, such as those that are the rule for example in the construction of vehicle bodies or engines, so-called deburring robot cells are used. Essentially there is a multi-axis robot in these manufacturing facilities, which guides the deburring tool on a pre-programmed path along the corresponding edge(s). If need be, these types of devices may be supplemented by imaging and/or tactilely functioning sensors that determine the precise position of the workpiece in the cell and/or the prevailing size of the burr that needs to be removed so that appropriate situation-dependent adaptation of processing parameters may occur.

In the case of a sensorless configuration of these types of deburring robot cells, great attention must be paid to the precise positioning of the workpiece in the cell, because otherwise the path of the deburring tool will not correspond precisely to the path required to achieve an optimum processing result; the path lies at a precisely defined distance and at a defined position or orientation to the respective workpiece edge.

But even in the case of sensor-supported deburring robot cells, the processing result is frequently suboptimum, because the results essentially depend upon path planning. Normally, path planning aims at making sure the tool axis of a rotating or rotationally symmetrical tool is always aligned perpendicular to the surface being processed. However, practice has shown that this type of alignment produces an optimum processing result only in rare cases and especially not in the case of complex paths that are spatially multi-dimensional.

Manual path planning or optimization, which is characterized by a multitude of experiments and corresponding assessments of the experiments, is not desirable because these experiments require a lot of time and result in high costs.

Conversely, particularly with high-technology applications, such as, for example, constructing power plants or engines and, in this case, very particularly, in the manufacturing of corresponding turbine blades, an optimum processing result is essential since otherwise proper operation of the devices is not at all possible. Because these types of devices are always comprised of a plurality of individual, at least partially identical components, such as, for example, turbine or engine blades, a high level of series stability when manufacturing of these types of components is an important goal, something which is being achieved only inadequately by the path planning methods represented in the current state of the art.

Consequently, the objective of the invention is making available a method that can achieve optimum results with the milling of chamfers close to the final contour or the deburring of workpiece edges. The method is aimed in particular at providing a path optimization that is required to achieve an optimum processing result, wherein this optimization should preferably take place in an automated manner and within a short time.

Accordingly, the kinematic sequence of motion is optimized by allowing for an additional rotation around an axis parallel to the tool axis with respect to kinematic and/or kinetic and/or workpiece-specific manufacturing criteria. Because the inventive method can be automated, the desired optimization of the path planning may take place quickly and securely. The level of series stability with deburring close to the final contour is significantly increased because of the optimized processing that results from the inventive method.

Additional preferred embodiments can be found in the following detailed description and the figures.

The basis of the inventive method is the realization that the use of robot-supported chamfering or deburring in the case of rotationally symmetrical tools possesses a degree of kinematic freedom that may be utilized to achieve the desired optimum processing results.

In contrast to path planning methods used in the prior art, which are normally aimed at making sure that the vector product of the tool axis of a rotating tool and surface normal of the workpiece surface are always pointing in the feed direction of the tool, other target requirements are used in accordance with the inventive method that can lead to achieving a better processing result than would be possible with an alignment of individual vectors in accordance with the prior art.

In other words, path planning optimized in accordance with the inventive method normally leads to the vector product of the tool axis of a rotating tool and surface normal of the workpiece surface not pointing in the feed direction at all times.

Consequently, the inventive method for optimized milling close to the final contour by means of a rotationally symmetrical tool, is characterized in that the kinematic sequence of motion is optimized by allowing for an additional rotation around an axis parallel to the tool axis with respect to kinematic and/or kinetic and/or workpiece-specific manufacturing criteria.

In this case, milling tools in particular are a possibility as rotationally symmetrical tools. The processing result is not affected by the inventive additional rotation, because an additional degree of freedom for programming the sequence of motion along a predetermined contour exists based on the rotational symmetry of the tool.

It is theoretically possible to perform the milling process manually, i.e., manually controlled by an operator. However, according to a preferred embodiment of the inventive method, this milling process is carried out in a robot-supported manner. Using an automated production means, which is robot-supported in most cases, is practically essential particularly when producing series components that are geometrically complex.

According to a further preferred embodiment, the milling is carried out by means of a CNC machine tool. Even though these types of machine tools in most cases offer a lower number of degrees of freedom as compared to tool robots, they are adequate, however, for many typical tasks and are then preferably used because of their more favorable procurement and maintenance costs.

Especially preferred embodiments of the inventive method use the path of the tool and/or its speed and/or its acceleration as the target variable for optimization. According to further preferred embodiments, kinematic characteristic values derived from the previously mentioned target variables may be used as an alternative or in addition.

Thus, a particularly preferred target variable may be for example that the angular acceleration of the milling tool either does not exceed a specific value or is minimized on average and over the entire milling path, because experiments have possibly shown that, when exceeding a specific limit value, tool vibrations and therefore inadequate processing results must be anticipated, which moreover are not exactly foreseeable and therefore especially critical.

A further especially preferred target variable according to the invention may consist of the rotation of the vector field, which is formed by the three vectors comprised of the tool axis, the surface normal of the workpiece surface as well as the respective vector cross-product, being equal to the null vector 0.

Achieving the goal of an optimum path planning is achieved in an especially preferred manner according to the invention in that the optimization of the kinematic sequence of motion is carried out by means of numeric methods. Alternatively, it may also be provided that in certain cases not only a numeric, but also an analytical, solution exists for the respective problem, which then may be used additionally or alternatively. In the most frequent cases, however, it will be impossible or possible only with disproportionately great effort to find an analytic solution, which is why problem solving with the aid of numeric methods is preferred.

Normally, optimizing the sequence of motion or the appropriate path planning on the basis of the additional degree of freedom belongs to the non-trivial class of np-complete problems or multidimensional non-linear optimization problems, which is why an analytical solution for the optimization problem may exist or be found and specified only in rare cases. According to the invention, the following numeric optimization methods are preferably used in particular:

the numeric method may be a recursive min-max game strategy;

the numeric method may be a variant of the method of the steepest gradient;

the simulated annealing method may be used as the numeric method;

a genetic algorithm may be used as the numeric method;

the evolution strategy may be used as the numeric method;

a variant of operation research may be used as the numeric method; especially preferably linearly overdetermined systems of equations to minimize the Gaussian least square may be used in this case; and

a Monte Carlo method may be used as the numeric method.

It is clear that the foregoing enumeration of numeric methods must not be regarded as definitive, in fact it represents a selection that is felt subjectively to be optimum, which in the future may be expanded at any time by other, for example, newly developed methods, and also includes all combinations of the cited methods with one another or with other expedient optimization methods.

The inventive method may be used in general for generating an optimized path for guiding a rotationally symmetrical tool, wherein this path may also serve to smooth a surface for example. According to a preferred embodiment, the inventive method is used, however, particularly to optimize paths or sequences of motion for manufacturing chamfers or for deburring workpiece edges.

According to an especially preferred embodiment, the method is used in particular for manufacturing chamfers, which are located on turbine blades, and/or for deburring the same.

The invention will be described in the following on the basis of examples along with the drawings.

### BRIEF DESCRIPTION OF THE DRAWINGS

FIG. 1 shows the position of a rotationally symmetrical tool 2 in relation to a workpiece 1 as well as the vectors 3, 4 and 6 defining this position.

FIG. 2A shows a section through a workpiece 1, the workpiece contour 7 to be processed, and the position of a tool coordinate system at various points of the workpiece contour 7 with path planning according to the prior art.

FIG. 2B shows a section through a workpiece 1, the workpiece contour 7 to be processed, and the position of a tool coordinate system at various points of the workpiece contour 7 with path planning according to the inventive method.

FIG. 3A shows a section through a square workpiece 1, the workpiece contour 7 that is to be processed, and the position of the vector 4 at various points of the workpiece contour 7 with path planning according to the prior art.

FIG. 3B shows a section through a square workpiece 1, the workpiece contour 7 that is to be processed, and the position of the vector 4 at various points of the workpiece contour 7 with path planning according to the inventive method.

### DETAILED DESCRIPTION OF THE DRAWINGS

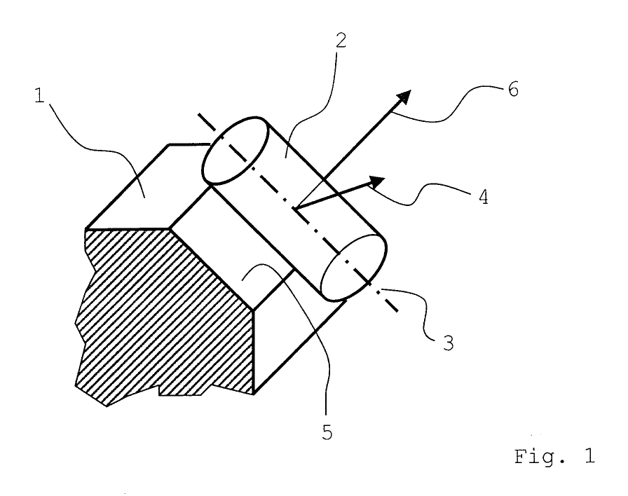

FIG. 1 shows the position of a rotationally symmetrical tool 2 in relation to a workpiece 1 as well as the vectors 3, 4, and 6 defining this position. In the depicted example, the rotationally symmetrical tool 2 may be a plain milling cutter, for example. The rotational axis 3 of this milling cutter defines a vector n_{w}. The workpiece 1 has a to-be-processed workpiece edge, which is embodied as chamfer 5 in the depicted example, but which can generally be described as the to-be-processed surface element dA. Situated perpendicularly on this chamfer 5 in an upright manner is a vector 4, which represents its surface normal n_{F} or the surface normal of the surface element dA. Finally, FIG. 1 also shows another vector 6, representing the vector cross-product of the vectors 3 and 4, and being according to the formula nₛ=(n_{w}×n_{F}). In accordance with the right-hand rule, this vector 6 is always perpendicular to both other vectors 3 and 4.

As evident directly from the sketch, it is obviously possible to rotate the workpiece 1 at will around the tool axis 3 without impacting the processing result. Because of the rotational symmetry of the tool 2, there exists an additional degree of freedom for programming the sequence of motion along a predetermined contour.

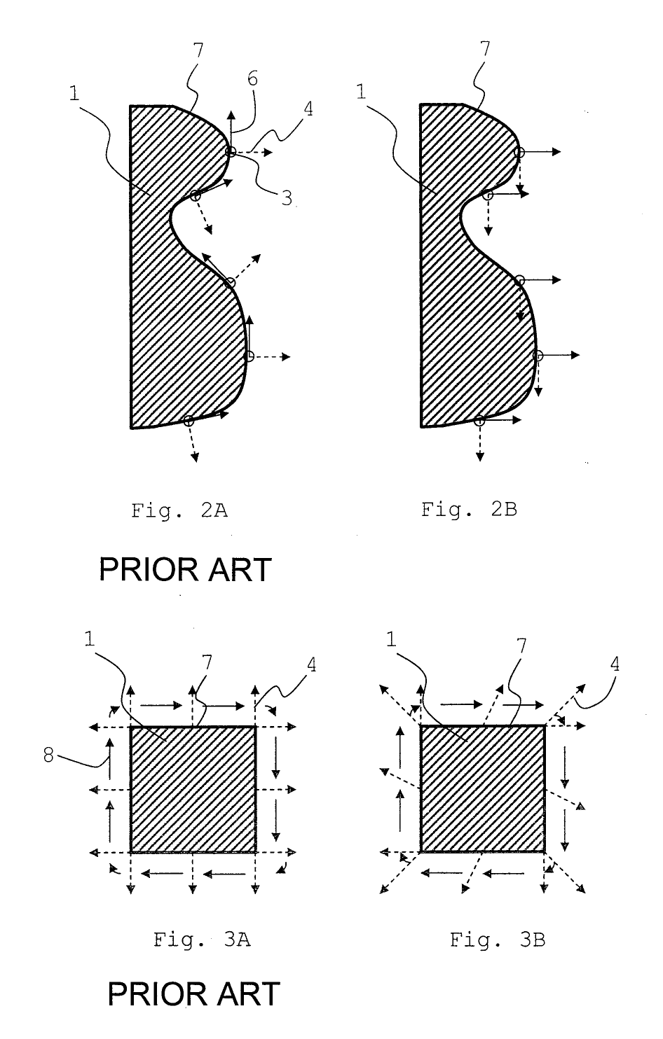

FIG. 2A shows a section through a workpiece 1, the workpiece contour 7 to be processed, and the position of a tool coordinate system at various points of the workpiece contour 7 with path planning according to the prior art. In this case, the vector 4 or the surface normal n_{F} is aligned at all times perpendicular to the workpiece contour 7 to be processed, indicated by the dashed line of the respective arrow located perpendicular to the workpiece contour 7. In the depicted representation, the tool axis 3 points into the image plane and is respectively represented by a small circle in the center of the tool coordinate system. The vector cross-product 6 is symbolized by the solid line of the respective second arrow of each tool coordinate system.

Because the rotationally symmetrical tool 2 according to the prior art must be adapted continuously to the respective position of the surface normal n_{F}, the necessity of constantly realigning the tool axis 3 of the rotationally symmetrical tool 2 arises and, thus, because of the movement, additional forces, particularly accelerating forces and centrifugal forces, are exerted on the tool 2, which may negatively impact positioning accuracy and thus the processing result.

FIG. 2B shows a section through the same workpiece 1, the workpiece contour 7 to be processed, and the position of a tool coordinate system at various points of the workpiece contour 7, wherein the tool path has now been optimized in accordance with the inventive method. The individual axes 3, 4 and 6 of the tool coordinate system also correspond to those from FIG. 2A.

In contrast to FIG. 2A, the tool path is optimized in such a way that the rotation of a vector field, which is formed from the three vectors 3, 4 and 6, yields precisely the null vector 0. In other words, the individual axes of the tool coordinate system point at all times in the same direction, only the position of the origin changes continuously. Because of the lacking rotation, no additional forces are exerted on the tool 2, whereby the processing results is impacted in a positive way.

FIG. 3A shows a section through a square workpiece 1, the workpiece contour 7 that is to be processed, and the position of the vector 4 at various points of the workpiece contour 7 with path planning according to the prior art. The position of the vector 4 (dashed line) in this case is at all times perpendicular to the workpiece surface or tool contour 7 to be processed. At the sharp corners of the depicted workpiece 1, the tool 2 must change its feed direction 8 by 90 degrees in a very short time, as indicated by the respectively bent, solid arrows. Because of this very quick and abrupt movement, undesirably high forces may in-turn be exerted on the tool 2, which may have a negative impact on the processing result.

In contrast to FIG. 3A, FIG. 3B shows the position of the vector 4 in the case of path planning that was optimized in accordance with the inventive method. In the case depicted here, the goal of optimization is minimizing the angular acceleration of the tool 2 (not shown) or at least not allowing it to exceed a defined value. As is evident in FIG. 3B, as the vector 4 increasingly approaches the nearest corner of the workpiece in the feed direction 8 (indicated by solid arrows), it tilts more and more forward so that its movement when reaching and sweeping over the workpiece corner turns out to be much less abrupt, thereby also reducing the associated forces acting on the tool 2, which ultimately also has a positive impact on the processing result.

### LIST OF REFERENCE NUMBERS AND ABBREVIATIONS

1 Workpiece

2 Tool, rotationally symmetrical tool

3 Tool axis, n_{w}

4 Surface normal, n_{F}

5 Chamfer/deburring, surface element dA

6 Vector cross-product, nₛ

7 Workpiece contour

8 Feed direction

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for optimized milling close to a final contour by a rotationally symmetrical tool, wherein a numeric optimization method is provided for an automatic control of kinematic sequences of motion, wherein an additional rotation around an axis parallel to a tool axis is optimized in terms of kinematic and/or kinetic and/or workpiece-specific manufacturing criteria.

2. The method according to claim 1, wherein the milling is carried out in a robot-supported manner.

3. The method according to claim 1, wherein the milling is carried out by a CNC machine tool.

4. The method according to claim 1, wherein a path and/or a speed and/or an acceleration and/or kinematic characteristic values derived therefrom are used as target variables for optimization.

5. The method according to claim 1, wherein the numeric method is a recursive min-max game strategy.

6. The method according to claim 1, wherein the numeric method is a variant of a method of a steepest gradient.

7. The method according to claim 1, wherein the numeric method is simulated annealing.

8. The method according to claim 1, wherein a genetic algorithm is used as the numeric method.

9. The method according to claim 1, wherein an evolution strategy is used as the numeric method.

10. The method according to claim 1, wherein a variant of operation research is used as the numeric method.

11. The method according to claim 10, wherein linearly overdetermined systems of equations are used to minimize a Gaussian least square.

12. The method according to claim 1, wherein a Monte Carlo method is used as the numeric method.

13. The method according to claim 1, wherein chamfers and/or deburrings of workpiece edges are milled.

14. The method according to claim 13, wherein the chamfers of turbine blades are milled and/or deburred.

15. The method according to claim 1, wherein a vector product of the tool axis of the tool and a surface normal to a workpiece surface is not pointing in a feed direction of the tool at all times during the milling.

16. The method according to claim 1, wherein a tool path is optimized such that a rotation of a vector field, which is formed from the tool axis of the tool, a surface normal to a workpiece surface, and a vector product of the tool axis of the tool and the surface normal to the workpiece surface, yields a null vector.

17. The method according to claim 1, wherein three individual axes of a tool coordinate system point at all times in a same direction during the milling.

18. The method according to claim 17, wherein only a position of an origin of the three individual axes changes continuously during the milling.

19. The method according to claim 1, wherein, as a vector which represents a surface normal to a surface of a workpiece increasingly approaches a nearest corner of the workpiece in a feed direction of the tool, the vector tilts increasingly forward.

20. A computer program embodied on a computer-readable medium for optimized milling close to a final contour by a rotationally symmetrical tool, wherein a numeric optimization method is provided for an automatic control of kinematic sequences of motion, wherein an additional rotation around an axis parallel to a tool axis is optimized in terms of kinematic and/or kinetic and/or workpiece-specific manufacturing criteria.
